(19) United States
(12) Patent Application Publication
(10) Pub. No.: US 2001/0039000 A1
(43) Pub. Date: Nov. 8, 2001

(54) Reading tutor for infants

(76) Inventor: Thomas Gregory Parsons, Whangaparaoa (NZ)

Correspondence Address: Thomas G. Parsons, 86 Shakespear Road, Whangaparaoa, 1463, NZ

(21) Appl. No.: 09/788,586

(22) Filed: Feb. 21, 2001

Related U.S. Application Data
(60) Provisional application No. 60/185,690, filed on Feb. 29, 2000.

(51) Int. Cl. G09B 11/02; B43L 15/00

(52) U.S. Cl. 434/166

(57) ABSTRACT

This invention comprises a method, and the technological means of implementing the method, to produce the ability to read in an infant during the first four years of life. Said technological means enhances the presentation of printed material at the same time that the appropriate sound of speech is presented. Said method comprises the regular use of such presentation during the period when said infant is acquiring language. A parent or caregiver can use this invention in such a way that said infant becomes aware of said printed material as an integral part of linguistic communication. With regular use of this invention, said infant learns to respond appropriately to printed material, using the same mental mechanisms with which said infant learns the spoken language, and in the same period of life.

### CROSS REFERENCE TO RELATED APPLICATIONS

This application is entitled to the benefit of Provisional Patent Application No. 60/185,690, filed Feb. 29, 2000.

### STATEMENT REGARDING FEDERALLY FUNDED RESEARCH

Not applicable.

### BACKGROUND OF THE INVENTION

Reading instruction is almost always aimed at children significantly older than those who can benefit from the present invention. The present invention is designed for maximum utility in children during the period from birth to their fourth birthday. Conventional methods suffer from many shortcomings, as will be discussed in greater detail below.

Current Practice of Reading Instruction

Reading instruction is typically begun with the informal exposure of pre-school children to printed material and individual letters. Formal instruction is usually not undertaken until school entry following the child's fifth or sixth birthday, and reading proficiency is developed over the next several years.

Followers of two major schools of thought, often called phonics and whole-language, have each contended for many years that their method is the better way to teach students to read. Each school of thought has produced an extensive research literature to back its claims, and the level of contention is such that the debate has often been called the “reading wars”.

For both sides, however, the main emphasis is on formal instruction during school years, with preschool years seen as useful only for foundational activities such as print awareness and letter naming, and infancy seen as irrelevant.

Common Problems of Reading Instruction

Perhaps 25% of children find reading difficult to master in school, despite the many hours devoted to reading instruction. A specific reading disability known as dyslexia is estimated to affect 5% to 15% of the population. This appears to be true regardless of whether the instructional method favors “phonics”, with its emphasis on letters, words, and the correspondence of graphemes (written or printed patterns) to phonemes (sounds of the spoken language), or “whole language”, with its emphasis on the natural reading experience.

Dyslexia is characterized by difficulty in reading, and is diagnosed more specifically by the presence of a subset of a list of specific reading-related performance problems. However, there is little agreement on the causes or cures of dyslexia, and even the condition itself defies unambiguous characterization. Recent research has shown dyslexia to be associated with unusually low levels of activity in the left inferior parietal area of the brain.

Current Attempts to Solve Problems of Reading Acquisition

In the political arena, much energy is expended on championing methods of instruction that embody either the “phonics” or “whole language” methods of instruction. The rationale is that the not-favored method is responsible for children's difficulties in reading, and the favored method would solve all problems.

In the academic arena, most efforts go into dissecting the act of reading into its presumed component parts or subskills. These include the alphabet principle, phonemic awareness, and the development of a mental lexicon. Difficulty in the learning and practice of reading are thought to be the result of deficient mastery of one or more subskills, such as eye-tracking across a line of print. Controversy surrounds the mechanism and timing of acquisition of the purported subskills. Also unsettled is the exact relationship between these subskills and ultimate success in skillful reading.

An extensive literature exists on all these topics, but despite the clear need, no single remedial program has shown itself to be so successful as to be universally accepted. Dyslexia specifically, and poor reading skills in general, have been shown to persist into adulthood and to have a negative impact on quality of life.

In addition, there are several programs such as that called “reading recovery” in New Zealand that attempt to rectify the failures of school reading instruction. Such programs have shown some successes. However, the results are neither so clear nor so cost-effective as to have produced general acceptance and use.

State of the Art: Earliest Reading, Natural and Induced

It is uncommon, but not rare, for children to show some ability to read at age 3, and to be somewhat proficient by age five, when the teaching of reading has usually not even begun for most children. This is almost always the result of early exposure to the printed word and encouragement (or at least facilitation) by parents. Studies have shown that the single most important variable associated with such early reading is parental time spent with children in a reading activity, rather than any specific technique of instruction.

Precocious readers have been shown to be exceptions to many of the generalizations about reading acquisition that have been deduced by observation of older readers. For example, “Maxine”, who began reading at age 21 months, showed a complete absence of “phonemic awareness”, a skill that is widely held to be an essential underpinning of the ability to read (studied by C. M. Fletcher-Flinn). Other early readers have shown an inability to spell, despite the fact that L. C. Ehri, an acknowledged expert in the field, maintains that reading and spelling are two sides of the same coin.

It is important to note that in all areas of reading, its teaching and practice, there is much controversy and little consensus among experts. There are many competing schools of thought concerning the way that reading is learned, the time at which it is (or can be) learned, and the best way to teach the skill.

Brain Development and Early Learning—The Foundation of This Invention

The weight of the human brain at birth is approximately 350 grams. One month later it has increased in weight by 70 grams: a 20% increase. By the infant's first birthday, the brain has doubled in weight to 700 grams, half its projected adult weight. By the second birthday the brain will be 75% of its adult size. At the same time, neurons are being produced and forming new networks of interconnection among themselves in response to environmental stimuli, or dying due to a lack of stimuli.

Experiments on animals, believed to be meaningful for humans, have shown that there are critical periods of brain development. During critical periods, brain development occurs in a special way. If development during a critical period is impaired, the resulting defects may never be rectified, or may only be partially rectified, with difficulty.

In particular, deprivation of visual stimuli during critical early brain development can result in the adult animal's inability to respond appropriately to visual stimuli for which it was not prepared in early life. Such disabilities may be highly specific. For example, a kitten surrounded solely by objects with vertical stripes until after this critical period has passed will become a cat unable to respond appropriately to the sight of objects with horizontal stripes.

The learning that occurs during this critical period is qualitatively different from the learning that happens later. During the period when the brain is rapidly growing, the visual cortex becomes structured in such a way as to respond usefully to visual stimuli. These responses appear to be based on an initial identification of the primitive elements of visual perception such as vertical or horizontal lines. The ability to perform such identification appears to be incorporated into brain structure during this period.

These facts about brain development are well established and have been known for decades. However, their significance has not been reflected in our child-rearing practices, despite widespread recognition of the desirability of doing so.

The importance of the first three years has led to the formation of groups such as Zero to Three (http://www.ZeroToThree.org) to promote awareness of the critical developmental importance of this period, and to promote programs designed to enhance desirable learning during this period.

Several studies of the effects of brain-developing intervention in early childhood show that many claims of lasting generalized benefits are insufficiently supported. However, in the specific area of language skills, these studies demonstrate that early enrichment produces lasting benefits.

There is thus a need to expose infants to the visual experience of the printed word, together with its communication function, at a very early age. However, at this age the infant's conscious awareness has not developed sufficiently for intelligent cooperation. This invention fills that need.

### SUMMARY

The present invention comprises a method, and devices that facilitate said method, of training infants to read while they are in the first four years of life.

The present invention achieves this result by exposing infants to the printed word in such a way that it is perceived as an element of communication, during a critical period of brain growth. In this way this invention engages the same mental mechanisms that enable infants to acquire the spoken language during this same period of life.

In one embodiment, printed material is presented on a computer screen together with illustrative graphic material. The parent sits at the computer, holding the infant so that the screen is visible, and reads the printed material aloud. Simultaneously, the parent causes each word to become enlarged or otherwise enhanced as it is read, by pressing the spacebar or clicking the mouse. As each word is enlarged, the previously read word returns to its original size or appearance, this being the same size and appearance as the rest of the printed material.

In this way the infant's attention is attracted to the printed word itself as a key feature of the communication. This feature of this invention is important to its function, and is a key distinction between this invention and traditional methods. The infant's attention is attracted to the word itself by its change in size or other enhancement of the word. The infant's attention is not distracted from the word itself by underlining or by pointing fingers or any other attention-attracting device that might call attention to itself rather than solely to the combination of letters that is the essential item to be stored in the infant's memory.

Objects and Advantages of the Present Invention

In contrast to current methods of producing the ability to read, the present invention does not require a conscious intention to learn on the part of the subject. Motivation is provided by the interaction with, and communication from, the parent or caregiver, which is rewarding in itself, and which is an essential component of the normal process of learning the spoken language. Adequate motivation to learn is thus far simpler to provide in this setting than it will be in later years in a school setting.

The present invention will protect the child from the risk of inadequate or even counterproductive reading instruction in school.

To the extent that it is widely used, the present invention will relieve the schools of the burden of reading instruction, leaving resources free for other pursuits.

Early mastery of reading will increase the child's safety, as words like “poison”, “danger” and “exit” will be meaningful from the beginning of the child's mobile years.

Early mastery of reading will permit early exploratory behavior to include learning from print sources, thus allowing the child to make academic progress at a rate limited only by intellect and inclination rather than by the lateness and other shortcomings of the current methods of reading instruction.

Early mastery of reading will transform the well-known developmental stage of asking “why”. The infant's ability to read will add the dimension of independent research and discovery to the usual verbal questioning.

The present invention will provide important neural patterning at a more fundamental level than that which can be acquired in later years, thus minimizing the risk that reading skill will be impaired by dyslexia.

One of the greatest challenges in decoding ordinary speech is breaking up a nearly continuous stream of sound into the segments that represent single words. The present invention will help the infant master normal speech by strengthening the training the infant receives in segmentation. Normally, parents help the infant achieve this by speaking “motherese”, a simplified speech stream with exaggerated pronunciation and pauses between words. The present invention intensifies this process in two ways. It enforces segmentation as each word is read and enhanced, and most importantly, it shows the infant a visual image of the individuality of words.

Problems Solved by the Present Invention

Many parents attempt to help their children learn to read by reading illustrated stories, and pointing to the words while reading them aloud. This is an excellent and often-successful method, which I have experienced both as learner and teacher. However, this traditional method requires at least two key discoveries by the infant, together with an application of mental discipline. First, the infant must recognize that some essential part of the communication lies in the relatively uninteresting black marks on the page. This recognition must be accompanied by the self-discipline to withdraw attention from the attractive picture and the reader's voice to examine those marks. Attention is the first essential condition for storing a memory. Motivation for such redirection of attention is usually lacking. Second, the infant must learn the significance of the caregiver's pointing finger as it indicates each word. The initial tendency is to pay attention to the moving, living finger. This cannot be overcome until the significance of pointing is understood, and even then it requires a conscious effort to redirect the attetion.

The present invention solves these problems by increasing the size of each printed word (or otherwise enhancing it) as it is read, thus making obvious the connection between the sound and the printed letter pattern. Furthermore, the increase in the size of the word makes the word itself into a more interesting and attention-commanding object than a static typeface. The brain and visual system are structured to pay attention to moving objects from a very early stage of development. No mental discipline is required. Thus the present invention eliminates these three barriers that hinder learning, even in a favorable learning environment.

The attention-demanding enhanced printed word in this invention also eliminates two other common problems with the pointing-finger method. First, a pointing finger often obscures the word being indicated. It is difficult to use a finger to indicate unambiguously exactly the key word and none other, without bringing the finger so close to the infant's line of sight as to hide the very image that must be seen. Furthermore, the mechanical nature of the word-enlargement process in the present invention ensures that each word is given equal emphasis. Where a caregiver might tire of the precision that pointing requires, and might tend to emphasize the “interesting” words, the present invention emphasizes each word equally as it is read. This presents more precisely the way that the print corresponds to the spoken sound. In this way the present invention maximizes the number and clarity of entries into the infant's mental database of print-to-sound relationships (more technically called grapheme-phoneme correspondences).

Failure to learn to read in school is often associated with lowered self-esteem and behavioral problems, as well as lower academic achievement and consequent continuing difficulties throughout life. The present invention prevents all of these negative consequences of the failure of traditional reading instruction.

### DRAWING FIGURES

Brief description of the Drawing Sheets

The illustrations provided on Sheets 1 through 6 illustrate a particular example of the graphic display that is a feature of this invention. The drawings do not show the invention itself in any physical or mechanical sense. They are provided to facilitate understanding of the written description given here. They show an example of a particular instance of the visual elements of this invention in any of its embodiments. However, they are solely illustrative rather than definitive. They will be referred to in this application when they may be helpful to clarify the operation of the visual display by reference to this single example of an unlimited number of possible visual displays.

### LIST OF REFERENCE NUMERALS

The numerals below appear on Sheet 1 to label components of the visual display. Sheets 2-6 illustrate the rest of the presentation example begun on sheet 1. No additional reference numerals are provided, as it is felt that this is unnecessary for a full and adequate understanding.

1. Border containing the entire graphic display

2. Pictorial element of graphic display

3. Caption as it originally appears, with no words enhanced

4. Appearance of the caption after one mouse click

5. Appearance of the caption after second mouse click

6. Appearance of the caption after third mouse click

It is felt that the remainder of the Figures are self-explanatory. They are presented partly for the sake of completeness and partly to illustrate that objectionable words may be present, but as explained in the description, can be changed by the parent.

### DESCRIPTION—MAIN EMBODIMENT

Description and Operation, Computer Embodiment

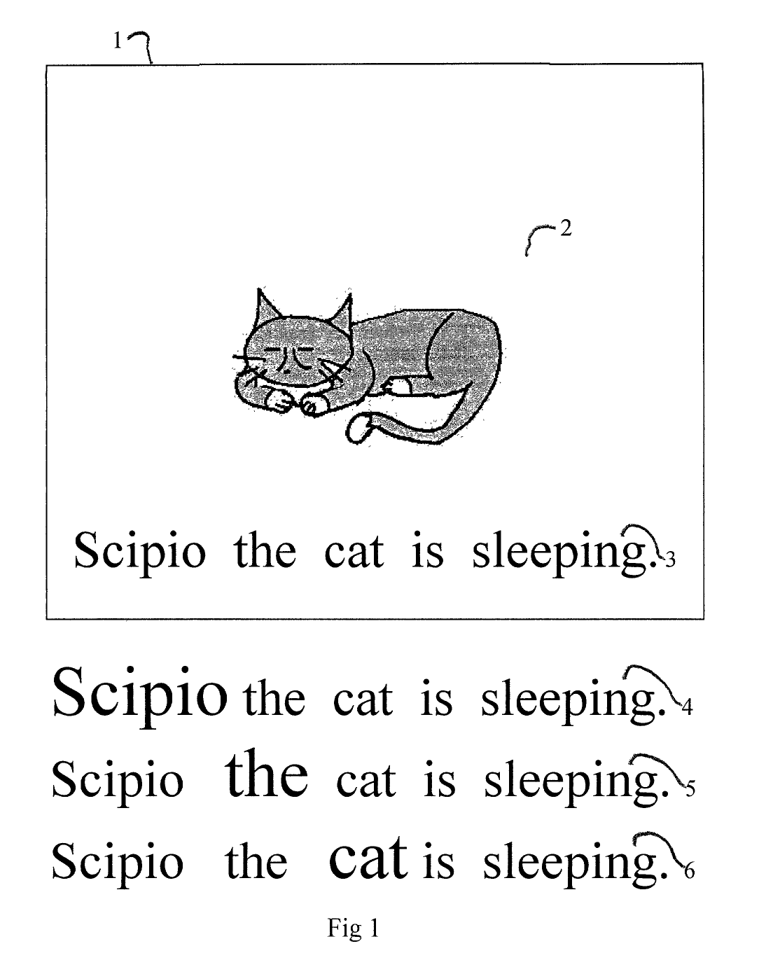

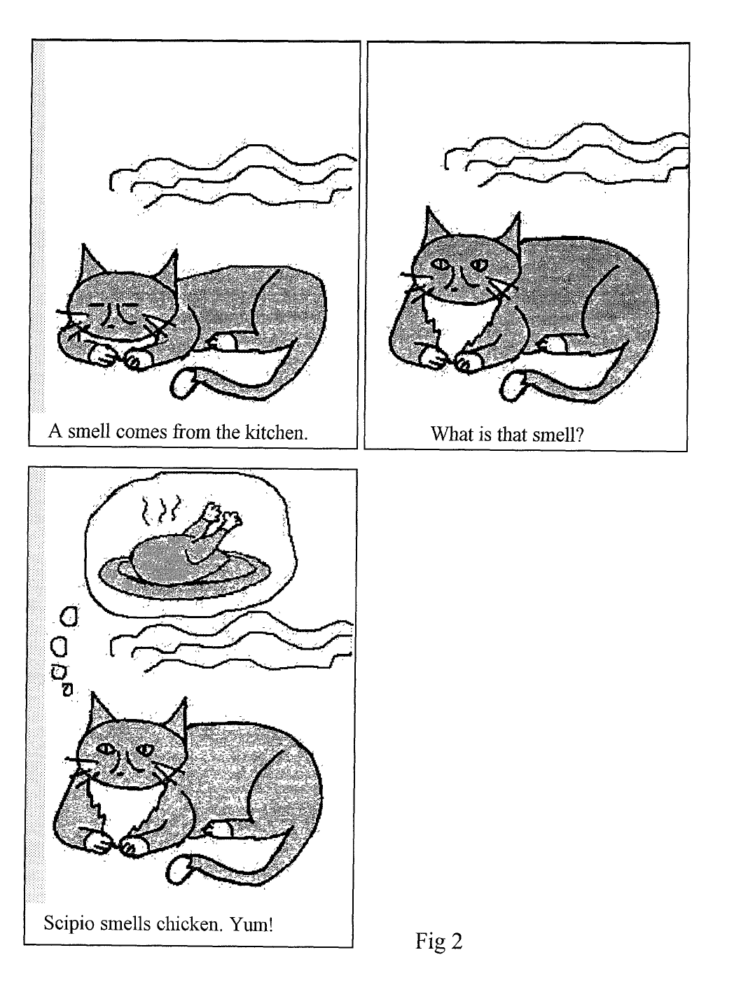

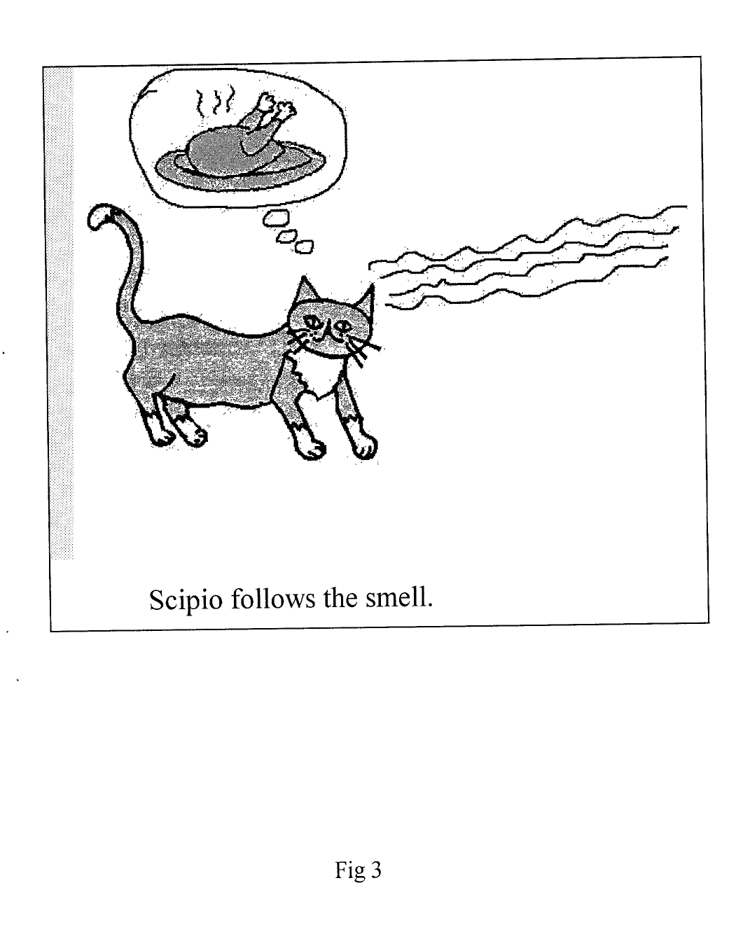

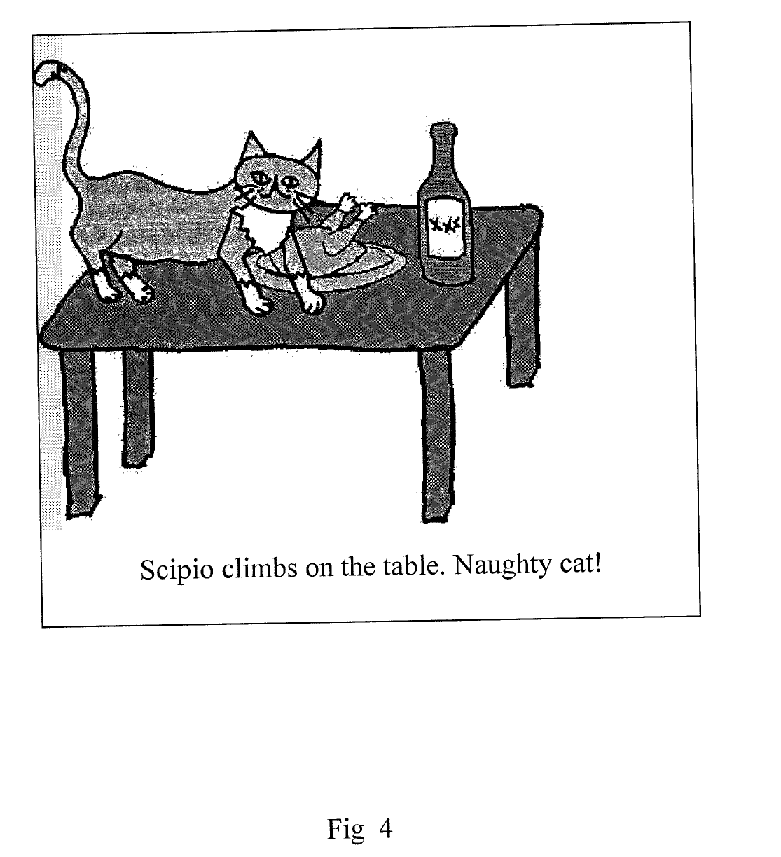

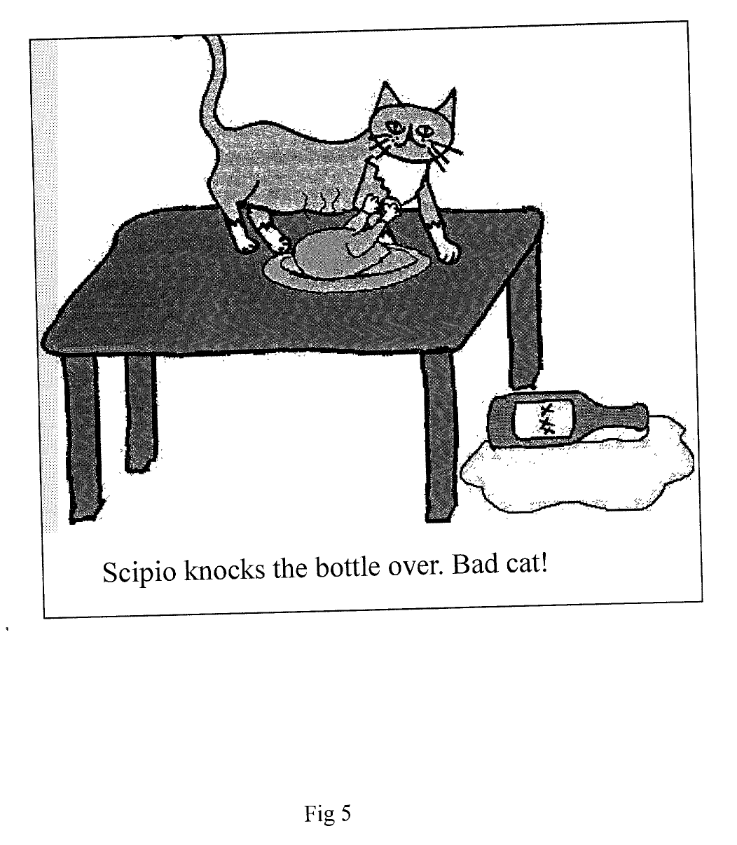

In the computer embodiment, the tutor is implemented by means of a software program running on a computer. The computer display screen is used to present the visual elements of the reading trainer, examples of said visual elements being depicted in FIGS. 1 through 6, and said presentation being controlled by keyboard and mouse. In this embodiment, an image is displayed (such as FIG. 1-1) comprising a graphic pictorial representation (such as FIG. 1-2) and a related caption (such as FIG. 1-3) consisting of printed material as in the specification of this invention.

To receive training, the infant optimally sits in the lap of the parent or caregiver, facing the computer display. The parent or caregiver reads the caption on each page, thus providing spoken sound appropriate to said printed material, and triggers the enlargement of each word as it is read. In this embodiment of this invention, each mouse-click or each press of the spacebar causes the words in said caption to become enlarged in sequential order, with each word returning to its original size simultaneously with the enlargement of the next. Thus the caption (FIG. 1-3) changes its appearance progressively to the appearance of FIG. 1-4, 1-5, 1-6 and so on. Such sessions are repeated approximately twice daily, with a total time expenditure of approximately 30 minutes per day, on approximately five days of each week. Significant variations in this regimen are acceptable, but regularity and frequency of sessions are important to achieving a favorable outcome.

It is important to note that the infant, especially in the first few months, need not always (or even often) pay attention to the visual display for the training process to occur. Different portions of the relevant neural networks will initially develop at different rates. It is important for the infant to become accustomed to the training sessions as regular events. Training sessions should be enjoyable events involving pleasant interaction with the parent. The parent should follow the complete procedure, even if the infant is passive or appears inattentive. However, if the infant is actively resistant or crying, the parent should deal with the cause of the distraction, whether it is hunger or discomfort. Training sessions should not be associated with unpleasant experiences for the infant.

The infant will be aware of details such as the parent's movements when advancing to each successive word, even before noticing the word-enhancing effect of the parent's movements. The infant will remember the sound of the words, and their pattern within training sessions, long before any meaning can be associated with them. The regular repetition of the sessions will first create memories of large scale physical and emotional events, including the regularly repeating sound patterns of a few specific presentations. Gradually, these remembered and expected patterns will gain finer detail and meaning in the infant's mind.

The parent must recognize that his own boredom must be suppressed, and his enthusiasm maintained, since infants are strongly affected by parental emotions. The parent's mastery of all elements of a presentation will be almost instantaneous. However, the infant will require weeks or months of repetition to integrate all elements of the presentation into a meaningful pattern. The repetition that causes boredom in the adult is a key part of the exercise for the infant. The very repetitiveness that bores the adult will give the infant a sense of security that comes from involvement in a familiar situation. As the training sessions become thoroughly familiar, and as the infant gains skill in directing his or her gaze, the visual component of the communication will be added to the foundation already built.

This progression is illustrated in FIG. 1-4, FIG. 1-5, and FIG. 1-6, which show the appearance of the caption after each successive press of the spacebar. Each press of the spacebar causes no change in any part of the display except for the size of a single element of the caption, thus focusing the attention of the infant on the active element of the communication. When the caption has been read completely, the parent causes the invention to display the next page by pressing the Page Down or right arrow key.

In the computer embodiment, printed material can be altered to suit the preferences of parents, using a simple text editor program. The printed material can thus be made relevant to the infant's own environment by the insertion of familiar and preferred names. For example, the cat named “Scipio” in a program currently in use with this invention, which is illustrated in FIGS. 1 through 6, can be given any name desired by the parent. “Dad” can become “daddy”, “father”, “Mom”, and “he” can become “she”, or the infant's own name can be inserted into a story, at the discretion of the parent. This enhances the relevance of the communication to the infant, and thus its effectiveness in training the infant's response.

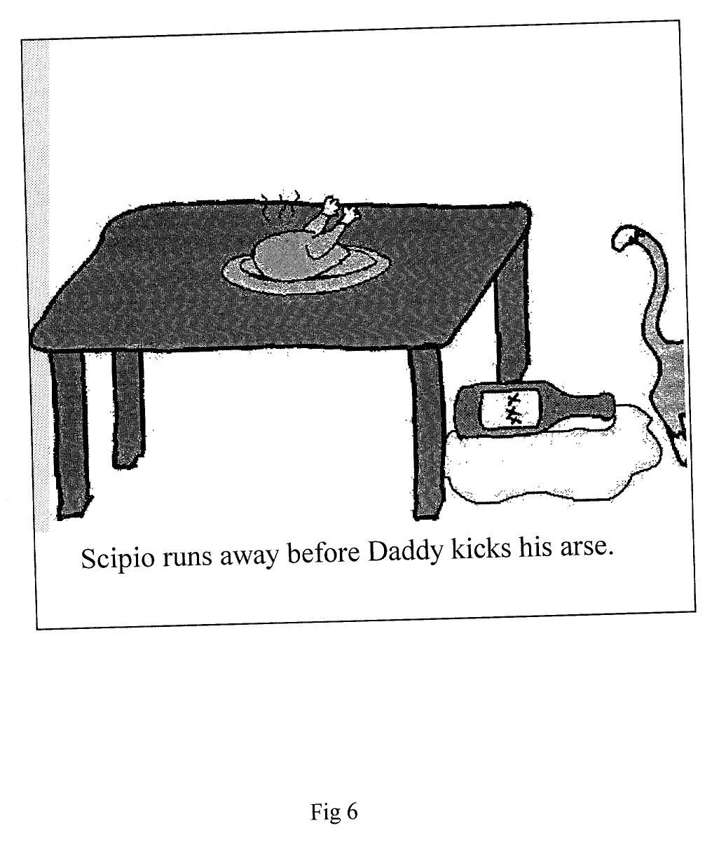

Furthermore, if a word or other element of a story is objectionable to a parent, as parts of FIG. 6 are likely to be, having been made thus for illustrative purposes, it can be altered by the parent. This flexibility of the computer embodiment is so great that parents can produce entirely new training modules by simple substitution of elements in computer files, without special tools or programming ability.

In this embodiment the invention can be distributed as computer files to parents and caregivers who already own a personal computer, at minimal cost.

### DESCRIPTION—ALTERNATIVE EMBODIMENT

Description and Operation—Game Machine Embodiment For use where a computer is unavailable or inappropriate, the same functions can be performed by any device that has a programmable visual display and sound output, similar to any of a wide variety of electronic games. This embodiment has the advantages of greater portability and lower cost than the computer required for the Computer Embodiment above. Additionally, this embodiment is as safe and durable as said games, and can be left with an unattended infant, who can interact with it at will. This embodiment can also perform the function of providing the sound appropriate to the printed material being presented, using either factory-provided sounds or by preference the recorded voice of a parent or caregiver.

In the game machine embodiment, this invention can provide tutorial benefit even in the absence of the caregiver.

### SCOPE OF THIS INVENTION

While the above description contains many specificities, these should not be construed as limitations on the scope of this invention, but rather as examples of some preferred embodiments thereof. Many other variations are possible. For example, the enhancement of a word could be triggered by the sound of the reader's voice, or the voice of the infant, rather than the reader's press of the spacebar.

Alternatively, such triggering could be effected by voice recognition software that would respond only to a correct pronunciation, or by such software operating in a mode to accept only a specified level of divergence from exact enunciation. With such triggering, adjusted to require progressively more precise enunciation, increment training could be used to improve both speech and reading capability in the infant, or in an older child with speech difficulties.

Alternatively, the triggering device such as the spacebar could be equipped with an attachment to permit the relatively uncoordinated action of the infant's hand to shift the focus of enhancement to each word in turn, thus allowing a significant degree of participation and control, and permitting the infant to display understanding and control at a stage of development when more sophisticated dexterity has not yet been acquired. This could enhance learning and emotional satisfaction by giving the infant a means to succeed in a communication task at a time when the coordination to perform complex speech and motor movement has not yet developed.

Furthermore, although the example provided in FIGS. 1-6 shows whole words only, it will be useful also, and it is the inventor's intention, to present single letters, portions of words, syllables, and groups of letters separately enhanced so as to show their sounds. A polysyllabic word, could, for example, appear enlarged in its entirety, but have an enhancing color shift from one syllable to the next as each is spoken. An alphabet tutorial of the style “A is for ants, that live in the ground. B is for beetles, that walk all around” is expected to be a common and basic presentation. The same type of extra enhancement can make it easier to recognize irregulars such as “ough” in “through” and “tough”.

Although enhancement or animation of the pictorial graphic element is usually to be avoided, so as to avoid distraction of the infant's attention from the printed word, action words such as “jump” and “bounce” might beneficially be accompanied by a small amount of animation of their subject in the pictorial graphic.

Additionally, once the beginning of literacy has been achieved, distraction of the infant's attention by animation of the pictorial graphic element will no longer be an issue. At this point, added educational, motivational, and entertainment effects can be provided by means of such animation. For example, animation can show the operation of the parts of a machine at the same time that the parts are named.

Accordingly, the scope of this invention should be determined not by the embodiments described, but by the general and universal fundamentals of the process described, together with the appended claims and their legal equivalents.

1. A method for producing the ability to decode the printed word in an infant who is in the first four years of life, said method comprising:
a. the repeated visual presentation of printed material, including words, portions of words, groups of letters, or single letters, together with
b. the presentation of the sound of speech appropriate to said printed material, and
c. the visual enhancement of said printed material, concurrent with said speech sound,
with said elements presented in close spatial and temporal proximity and in such a manner as to direct said infant's attention to said elements,
whereby said infant's normal language acquisition processes will act to include the ability to assign sound-equivalents to printed words, portions of words, groups of letters, or single letters, these abilities collectively being known as the ability to read, as a part of the communication skills that are normally learned during the first years of life, and
whereby the need for said infant to learn to read at a later age, using formal processes that often fail, is eliminated.

2. A machine comprising devices to produce:
a. visual representations of printed material, including words, portions of words, groups of letters, or letters, and
b. the sound of said printed material being spoken,
juxtaposed in such a way, or combined into a single device, such that said elements are produced in close spatial and temporal proximity to each other and in such a manner as to direct an infant's attention to said elements, said infant being in the first four years of life,
whereby the experiences by which said infant would normally acquire speech communication skills during the first years of life, will in addition include experiences that produce in said infant the ability to decode the written representation of words and the sounds represented by letters and groups of letters, thus producing the ability to read, and
whereby said inculcation of the ability to read is incorporated into a natural process that proceeds smoothly in the vast majority of children, rather than being taught at a later age by intellectual processes that often fail.

3. A training instrument comprising:
a. a visual display device capable of displaying printed material, including words, portions of words, groups of letters, and single letters, and also capable of enhancing the salience of portions of the display, and
b. a sound production device capable of producing that sound appropriate to the currently enhanced portion of said printed material,
whereby the attention of an infant in the first four years of life is drawn simultaneously to said enhanced printed material and to said sound appropriate to said printed material, thus engaging the natural language acquisition facility of said infant in such a way as to produce the ability to read.
